(19) United States
(12) Patent Application Publication
(10) Pub. No.: US 2012/0075844 A1
(43) Pub. Date: Mar. 29, 2012

(54) LED COASTER

(75) Inventors: Kazuya Imagi, Yokohama (JP); Takashi Noguchi, Yokohama (JP)

(73) Assignee: OSRAM AG, Muenchen (DE)

(21) Appl. No.: 13/375,788

(22) PCT Filed: Jun. 3, 2010
(86) PCT No.: PCT/JP2010/059444

§ 371 Date: Dec. 2, 2011

(30) Foreign Application Priority Data
Jun. 12, 2009 (JP) 2009-140651

(51) Int. Cl. F21L 4/00

(52) U.S. Cl. 362/194

(57) ABSTRACT

An LED coaster may include: a light transmitting cover, on the upper surface of which an object is placed; a bottom cover attached to the lower surface of the light transmitting cover; a substrate provided between the light transmitting cover and the bottom cover, having an LED mounted on a component surface on the light transmitting cover side and having a switch that turns the LED on and off mounted on a solder surface on the bottom cover side; batteries contained in a battery storage part of the bottom cover to supply electric power to the LED; two rubber pads attached to the bottom surface of the bottom cover; and a switch pad that is attached to the inside of the bottom cover in a vertically moveable manner and on which a switch pressing part facing the switch is arranged. The two rubber pads and the switch pad may be arranged near the outer periphery of the bottom of the bottom cover at approximately equal intervals in a circumferential direction, and the diameter of the switch pad may be set to just under ½ of the diameter of the LED coaster.

### RELATED APPLICATIONS

The present application is a national stage entry according to 35 U.S.C, §371 of PCT application No. PCT/JP2010/059444 filed on Jun. 3, 2010, which claims priority from Japanese application No. 2009-140651 filed on Jun. 12, 2009.

### TECHNICAL FIELD

Various embodiments relate to a coaster on which a cup, such as a glass, containing a beverage, such as alcohol, soft drinks, water, etc. is rested and, particularly, to an LED coaster capable of illuminating a cup from the bottom in order to create a comfortable atmosphere, particularly when people enjoy eating and drinking.

### BACKGROUND

One example of a conventional LED coaster 110 will be explained by referring to FIGS. 9-13. FIG. 9 is a top view of the LED coaster 110. FIG. 10 is a bottom view showing the conventional LED coaster 110. FIG. 11 is a side view of the conventional LED coaster 110. FIG. 12 is a side view where the conventional LED coaster 110 has been placed on e.g. a table. FIG. 13 is a side view where the conventional LED coaster 110 has been placed on e.g. a table and a cup containing a beverage has been put on the coaster.

The conventional LED coaster 110 has a circular light transmitting cover 101 on its upper surface (on which a cup is rested), and an upper-surface circumferential cover 102 is provided to cover the upper-surface outer periphery of the light transmitting cover 101. The light transmitting cover 101 is not entirely transparent but has a transparent light transmitting part 101a formed approximately at the center of its upper surface and a transparent light transmitting part 101b formed on its side surface. Through these light transmitting parts 101a and 101b, the light from the LED (light emitting diode) is transmitted to the outside.

Though not shown in the drawings, the LED is arranged on the inside (reverse side) of the light transmitting part 101a, so that the LED faces the light transmitting part 101a. Thus, the LED is to be placed approximately at the center of the LED coaster 110. The LED is mounted on a non-illustrated substrate.

The bottom surface of the LED coaster 110 includes a circular bottom cover 103. In the vicinity of the outer periphery of the bottom cover 103, three rubber pads 105 are provided at approximately equal intervals. When the LED coaster 110 is placed on the table, etc., the rubber pads 105 contact the table, etc.

A switch pad 104 for lighting the LED is provided at a position slightly off from the center of the bottom cover 103. As described above, since the LED is located approximately at the center of the LED coaster 110, the switch pad 104 is positioned slightly off from the center of the LED coaster 110 for the convenience of the layout of the substrate.

At a predetermined position on the bottom cover 103, an elongated-hole-type battery cover 106 is screwed with a screw 107. Two button batteries are stored on the inside (reverse side) of the battery cover 106, facing it. The button batteries are the power supply for the LED.

The switch pad 104 is attached to the bottom cover 103 in a vertically moveable manner (moveable in the direction of the thickness of the LED coaster 110). In the normal posture (state) of the LED coaster 110, in which the light transmitting cover 101 is on top and the bottom cover 103 below it, the flange of the switch pad 104 is mounted on the (not illustrated) step portion of the circular hole in the bottom cover 103. In this state, there is a gap (play) between the switch on the substrate and the switch pad 104.

If the LED coaster 110 in its normal posture (state) is not located on e.g. a table, as shown in FIG. 11, the relationship h2>h1 is satisfied, where h1 designates the height of the rubber pads 105 protruding from the bottom cover 103, and h2 designates the height of the switch pad 104 protruding from the bottom cover 103.

When the LED coaster 110 in its normal posture (state) is located on e.g. a table, as shown in FIG. 12, the weight of the LED coaster 110 is applied to the switch pad 104 which then moves into the LED coaster 110 by the gap (play) between itself and the switch on the substrate and contacts the switch on the substrate. The LED coaster 110 is placed on a table, etc. in such a manner that the two rubber pads 105 on the button battery side and the switch pad 104 contact the table, etc. Then, the relationship h2>h2′>h1 is fulfilled, where h2′ represents the height of the switch pad 104 protruding from the bottom cover 103.

Even if the switch pad 104 contacts the switch on the substrate, the switch is not operated by this contact alone. The switch is operated and the LED is lit when the switch pad 104 presses the switch on the substrate.

When next, in the normal posture (state) of the LED coaster 110, where it is placed on e.g. a table, a cup 108, etc. containing a beverage is placed on the LED coaster 110, the switch pad 104 moves further into the LED coaster 110 because of the weight of the cup 108, etc. and presses the switch on the substrate. In this manner, the switch is operated and the LED is lit.

Depending on the weight of the cup 18, etc., when the cup 108 is comparatively light, as shown in FIG. 13, the height h2″ of the switch pad 104 protruding from the bottom cover 103 is still greater than the height h1 of the rubber pads 105, and the relationship h2>h2′>h2″h1 is satisfied.

Under this state, the rubber pads 105 opposite the button batteries float over the table. Therefore, the LED coaster 110 is in an unstable state and, in some cases, users of the LED coaster 110 may be dissatisfied.

If the cup 18, etc. is heavy and all (three) rubber pads 105 contact the table, the LED coaster 110 becomes stable.

Further, for example, the following coaster with a lighting device is suggested. This coaster with the lighting device is constructed in such a manner that, in order to overcome the inconvenience of a person having to turn the switch on and off, a placing table with a placing surface as its upper surface on which the cup is placed is supported by a coil spring in a vertically moveable manner. The elastic force of the coil spring is set to a strength that allows the placing surface to sink when a cup containing a predetermined amount or more of a beverage is placed on it. On the upper surface of the supporting table, a printed circuit board is fixed on top of which the LED and the push switch are attached. If the cup is placed on the placing surface and the cup contains a predetermined amount or more of a beverage, the placing table sinks because of the weight of the cup and the push switch is turned on so that the LED is lit (see, e.g., JP Pat. Appl. Publ. No. 2006-20926).

The conventional LED coaster 110 is shown in FIGS. 9-13. If the cup 108, etc. containing a beverage is comparatively light, the rubber pads 105 opposite the button batteries float over the table. Therefore, the LED coaster 110 is in an unstable state (it is shaky), and in some cases, users of the LED coaster 110 may be dissatisfied.

### SUMMARY

Various embodiments provide an LED coaster that is in a stable state and not shaky, when the LED coaster is placed on a table and a cup, etc. containing a beverage is placed on the LED coaster.

An LED coaster according to various embodiments of the present invention includes: a light transmitting cover, on the upper surface of which an object is placed; a bottom cover attached to the lower surface of the light transmitting cover; a substrate provided between the light transmitting cover and the bottom cover, having an LED mounted on a component surface on the light transmitting cover side and having a switch that turns the LED on and off mounted on a solder surface on the bottom cover side; batteries contained in a battery storage part of the bottom cover to supply electric power to the LED; two rubber pads attached to the bottom surface of the bottom cover; and a switch pad that is attached to the inside of the bottom cover in a vertically moveable manner and on which a switch pressing part facing the switch is arranged, characterized in that the two rubber pads and the switch pad are arranged near the outer periphery of the bottom of the bottom cover at approximately equal intervals in a circumferential direction, and the diameter of the switch pad is set to just under ½ of the diameter of the LED coaster.

In accordance with some embodiments the LED mounted on the substrate is positioned approximately at the center of the LED coaster.

In accordance with some embodiments the light transmitting cover has light transmitting parts approximately at its center and on its side surface, through which the light of the LED is transmitted.

In accordance with some embodiments a switch pressing part of the switch pad is arranged approximately at the center of the switch pad.

In accordance with some embodiments the switch pressing part is cross-shaped.

In accordance with some embodiments, in a state where the LED coaster is not placed on a table, etc., the relationship d1>d2 is fulfilled, where d1 designates the size of the switch pad in the direction in which it protrudes outward from the bottom of the bottom cover of the switch pad, and d2 designates the size of the rubber pads in the direction in which they protrude outward from the bottom cover.

In accordance with some embodiments the two rubber pads are arranged at an interval of about 120 degrees, with the battery storage part of the bottom cover lying between the rubber pads.

In accordance with some embodiments the battery storage part of the bottom cover is formed as a concave portion which is a convex portion when seen from the inside of the bottom cover and, after the batteries are stored in the battery storage part, the battery storage part is closed with the battery cover.

In accordance with some embodiments holes in the protruding part of the switch pad are guided to a plurality of pins set up on the reverse side of the bottom cover, so that the switch pad can move in a direction of the thickness of the LED coaster.

In accordance with various embodiments the two rubber pads and the switch pad of the LED coaster are arranged near the outer periphery of the bottom of the bottom cover at approximately equal intervals in the circumferential direction, and that the diameter of the switch pad is set to just under ½ of the diameter of the LED coaster, so that it is possible to provide an LED coaster that is in a stable state and not shaky when it is placed on the table and the cup, etc. containing a beverage is placed on it.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows Embodiment 1 and is a top view of the LED coaster 10.

FIG. 2 shows Embodiment 1 and is a side view of the LED coaster 10.

FIG. 3 shows Embodiment 1 and is a bottom view of the LED coaster 10.

FIG. 4 shows Embodiment 1 and is a perspective view of the LED coaster 10 as seen from the bottom side.

FIG. 5 shows Embodiment 1 and is a sectional view taken along the A-A line in FIG. 3.

FIG. 6 shows Embodiment 1 and is a sectional view taken along the B-B line in FIG. 3.

FIG. 7 shows Embodiment 1 and is a plan view of the inside of the LED coaster 10 with the light transmitting cover 1 removed.

FIG. 8 shows Embodiment 1 and is a perspective view of the inside of the LED coaster 10 with the light transmitting cover 1 removed.

FIG. 9 is a top view of a conventional LED coaster 110.

FIG. 10 is a bottom view of a conventional LED coaster 110.

FIG. 11 is a side view of a conventional LED coaster 110.

FIG. 12 is a side view showing a conventional LED coaster 110 placed on a table, etc.

FIG. 13 is a side view showing the state where a conventional LED coaster 110 is placed on a table, etc. and a cup containing a beverage is placed on it.

### DETAILED DESCRIPTION

The following detailed description refers to the accompanying drawings that show, by way of illustration, specific details and embodiments in which the invention may be practiced.

### Embodiment 1

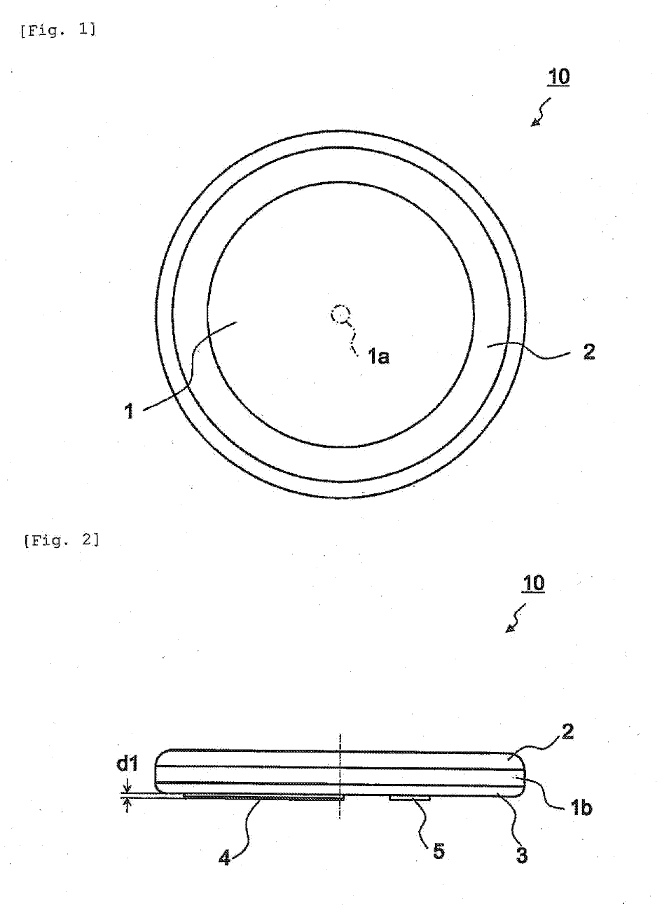

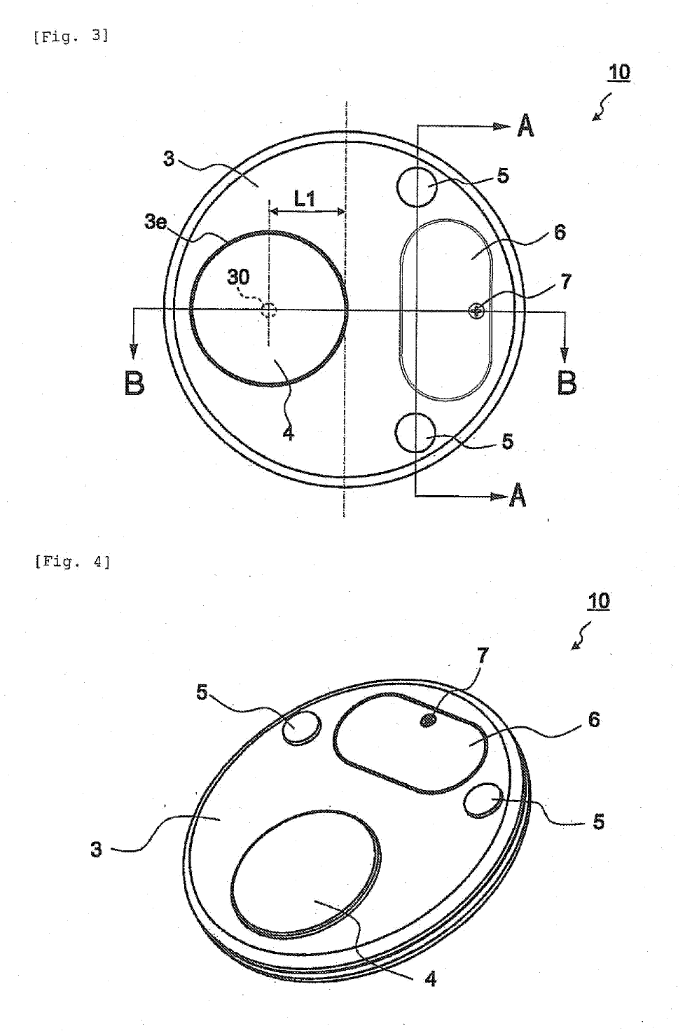

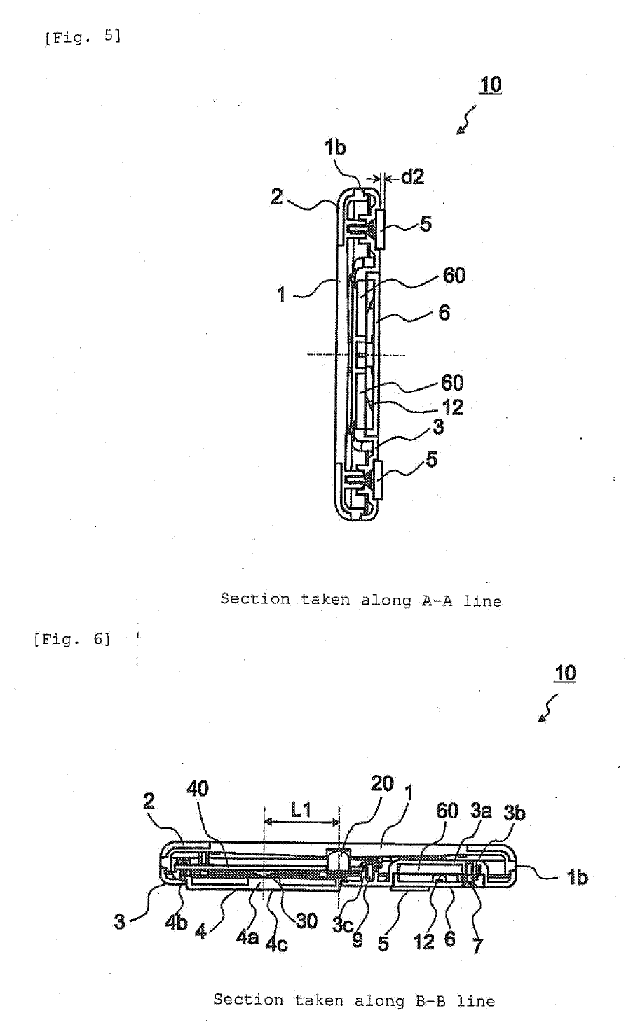

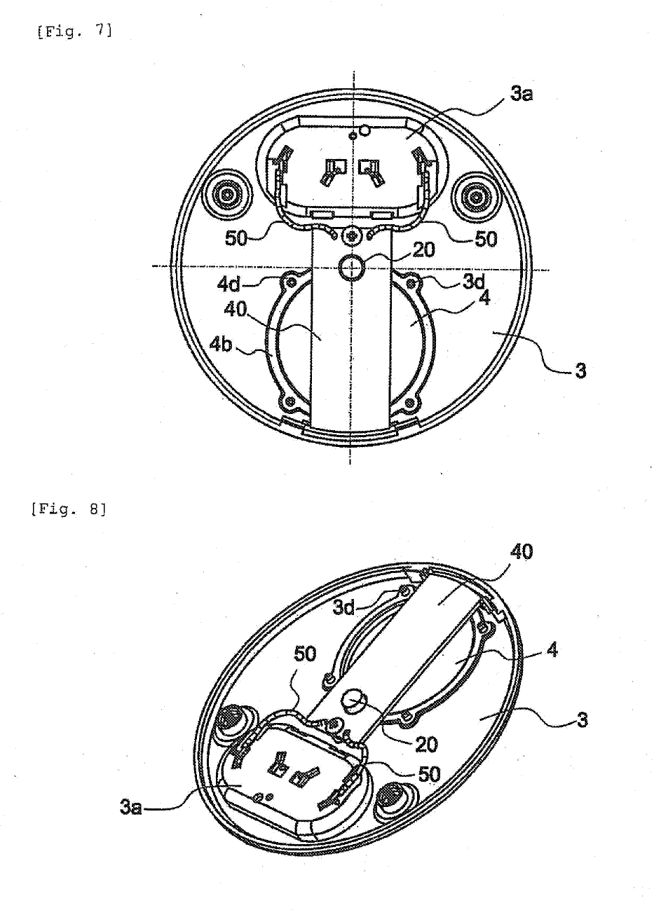

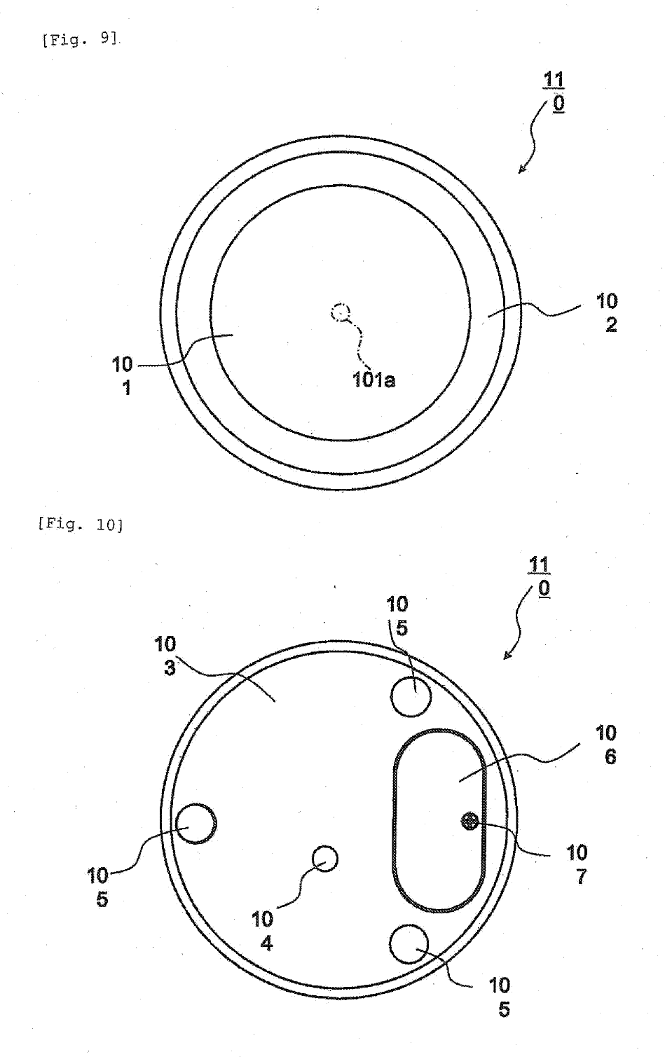

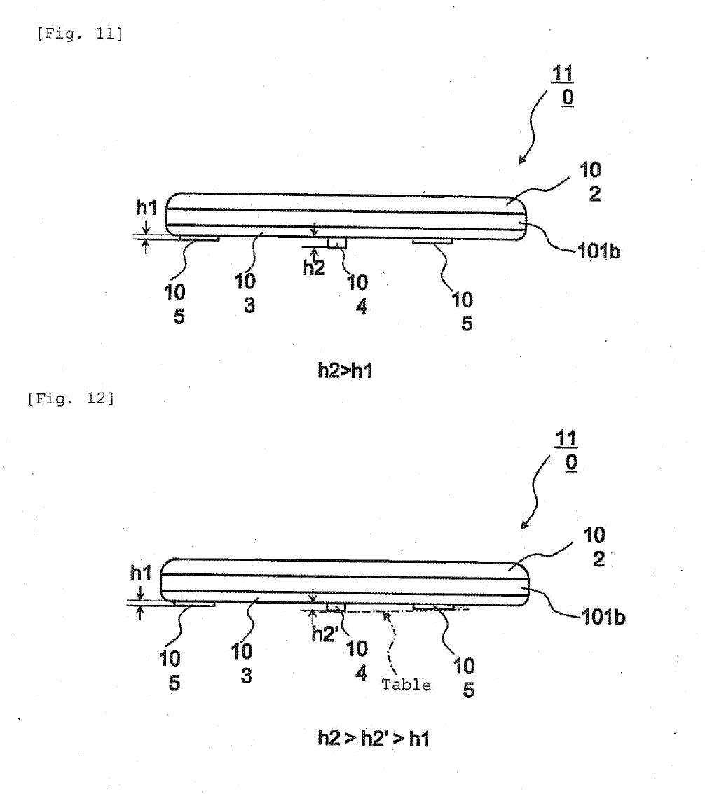

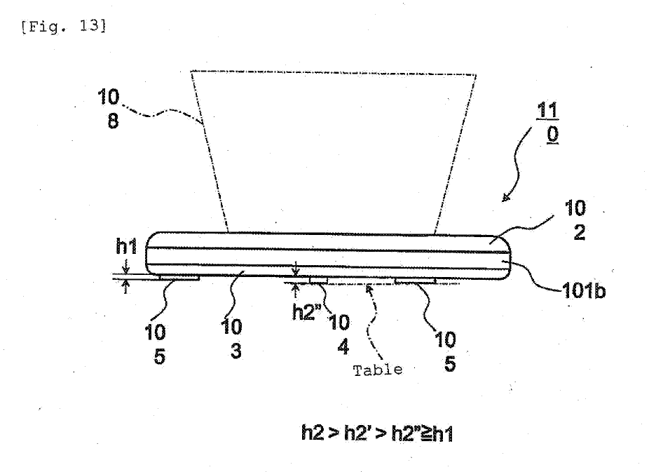

FIGS. 1-8 show Embodiment 1. FIG. 1 is a top view of the LED coaster 10. FIG. 2 is a side view of the LED coaster 10. FIG. 3 is a bottom view of the LED coaster 10. FIG. 4 is a perspective view of the LED coaster 10 as seen from the bottom side. FIG. 5 is a sectional view taken along the A-A line in FIG. 3. FIG. 6 is a sectional view taken along the B-B line in FIG. 3. FIG. 7 is a plan view of the inside of the LED coaster 10 with the light transmitting cover 1 removed. FIG. 8 is a perspective view of the inside of the LED coaster 10 with the light transmitting cover 1 removed.

Referring to FIGS. 1-8, the structure of the LED coaster 10 will be explained.

As shown in FIG. 1, the upper surface (upper portion) of the LED coaster 10 is the same as the one of the conventional LED coaster 110. Namely, the LED coaster 10 has the circular, plastic light transmitting cover 1 on its upper surface (on which an object, e.g., a cup, is placed) and it has an upper surface circumferential cover 2 that covers the outer peripheral part of the upper surface of the light transmitting cover 1. The light transmitting cover 1 is not entirely transparent but has a transparent light transmitting part 1a formed approximately at the center of its upper surface and a transparent light transmitting part 1b (see FIG. 2) formed on its side surface. From these light transmitting parts 1a and 1b, the light of the LED (light emitting diode) is transmitted to the outside.

The bottom of the LED coaster 10 includes the circular bottom cover 3. In the vicinity of the outer periphery of the bottom of the bottom cover 3, two rubber pads 5 and one switch pad 4 with a large diameter are provided (see FIG. 3).

The LED coaster 10 in the present embodiment differs from the conventional LED coaster 110 as follows:
(1) Three rubber pads 105 are used for the conventional LED coaster 110. On the other hand, two rubber pads 5 are used for the LED coaster 10 in the present embodiment. More precisely, the two rubber pads 5 on the side of the battery cover 6 (see FIG. 3) are provided in the same manner as the two conventional rubber pads 105.
(2) On the side opposite the battery cover 6 (see FIG. 3), one rubber pad 105 is used for the conventional LED coaster 110. On the other hand, for the LED coaster 10 in the present embodiment, the switch pad 4 is used instead of a rubber pad 5.
(3) The circular switch pad 4 does not have the small diameter of the conventional switch pad 104 but has a diameter larger than the diameter in the conventional art. According to one example, in case the diameter of the LED coaster 10 is about 90 mm, the diameter of the switch pad 4 is about 40 mm. The diameter of the conventional switch pad 104 is about 7 mm.

The two rubber pads 5 are arranged at an interval of about 120 degrees, with the battery cover 6 of the bottom of the bottom cover 3 lying between these pads.

The one switch pad 4 with the large diameter is arranged inside a hole 3e in the bottom cover 3 near the outer periphery on the side opposite to the battery cover 6 of the bottom of the bottom cover 3, approximately in the middle between the two rubber pads 5 (about 120 degrees).

When placed on a table, etc., the LED coaster 10 is supported by the table, etc. at three points, i.e. the two rubber pads 5 provided near the outer periphery of the bottom of the bottom cover 3, and the one switch pad 4 having the large diameter. Therefore, the LED coaster 10 is stable and not shaky.

When placed on a table, etc. in the normal posture (state), the conventional LED coaster 110, too, is supported by the table, etc. at the three points, i.e. the two rubber pads 105 and the switch pad 104. However, since the switch pad 104 is located near the center of the LED coaster 110, this LED coaster 110 lacks stability.

As shown in FIGS. 3 and 4, an elongated-hole-type battery cover 6 is fixed by a screw to a boss part 3b (see FIG. 6) provided in the battery storage part 3a (see FIGS. 6-8) of the bottom cover 3.

The battery storage part 3a of the bottom cover 3 is formed as a concave portion which has a convex shape with respect to the inside of the bottom cover 3.

As shown in FIG. 2, the switch pad 4 protrudes outward from the bottom of the bottom cover 3 by the size d1. According to one example, d1 is about 1.3 mm.

As shown in FIG. 5, the rubber pads 5 protrude outward from the bottom of the bottom cover 3 by the size d2. According to one example, d2 is about 1.0 mm.

The inner structure of the LED coaster 10 will be explained by referring to FIGS. 5-8.

An LED 20 is mounted on the component surface of a rectangular substrate 40. The substrate 40 is a single-sided substrate with one surface as a component surface and the other surface as a soldering surface. In this case, the substrate 40 is fixed to the boss part 3c (see FIG. 6) of the bottom cover 3 by the screw 9 (see FIG. 6) so that the component surface of the substrate 40 is on the side facing the light transmitting surface cover 1 and the soldering surface of the substrate 40 is on the side facing the bottom cover 3.

Here, the layout of the substrate 40 and the positional relationship between the substrate 40 and the bottom cover 3 are chosen so that the LED 20 is located approximately at the center of the LED coaster 10.

On the soldering surface of the substrate 40, a switch 30 (see FIG. 6) is mounted that turns the LED 20 on/off. The switch 30 is arranged to face a switch pressing part 4a (see FIG. 6) provided approximately at the center of the switch pad 4.

Lead wires 50 derived from a pair of battery terminals (not shown in the drawings) provided on the side of the battery storage part 3a of the bottom cover 3 that faces away from the battery cover 6, pierce through the substrate 40 from the component surface and are soldered to the soldering surface.

As shown in FIGS. 6-8, the switch pad 4 (partially blocked from view by the substrate 40) assumes an approximately circular shape and is a saucer-shaped object made of resin. The saucer assumes an outwardly convex shape. The base of the saucer is a circular placing surface 4c when the switch pad 4 is placed on a table, etc. Its side wall is set up from the outer peripheral edge of the circular placing surface 4c, and an annular flange part 4b is formed outward from the inner end part of the side wall, approximately parallel to the placing surface 4c. Along the outer peripheral part of the annular flange part 4b, approximately semi-circular protruding parts 4d (see FIG. 7) protruding outward are formed at approximately equal intervals (90 degrees) in the circumferential direction. On the respective four projecting parts 4d, circular holes are bored (not shown in the drawing).

On the reverse side of the bottom cover 3, pins 3d are set up, corresponding to circular holes in the four protruding parts 4d of the switch pad 4. The circular holes in the four protruding parts 4d of the switch pad 4 with the predetermined gaps between them fit to the pins 3d. Thus, the switch pad 4 is positioned by the pins 3d of the bottom cover 3 and is moveable in the direction of the thickness of the LED coaster 10 (vertically).

Approximately at the center of the reverse side (on the inside of the LED coaster 10) of the switch pad 4, a switch pressing part 4a (see FIG. 6) for pressing a switch 30 of a substrate 40 is formed. The switch pressing part 4a, though not shown in the drawing, assumes the shape of e.g. a cross. However, the shape of the switch pressing part 4a is not limited to a cross but can be selected at will.

As described above, a pair of battery terminals (not shown in the drawing and mutually independent) is provided on the side of the battery storage part 3a of the bottom cover 3 that faces away from the battery cover 6. On the other hand, battery terminals 12 are provided on the battery cover 6 as well. The battery terminals 12 are a pair of terminals that are coupled with each other (with electrical continuity).

A leaf spring is used both for the pair of battery terminals (not shown in the drawing and mutually independent) provided on the side of the battery storage part 3a of the bottom cover 3 that faces away from the battery cover 6, and for the battery terminals 12 of the battery cover 6.

The electric path between the substrate 40 and the button batteries 60 (one example of battery) is, e.g., as follows: one lead wire 50 derived from the substrate 40→one of the pair of battery terminals provided on the side of the battery storage part 3a of the bottom cover 3 that faces away from the battery cover 6→one button battery 60→one of the pair of battery terminals 12 of the battery cover 6→the other of the pair of battery terminals 12 of the battery cover 6→the other button battery 60→the other of the pair of battery terminals provided on the side of the battery storage part 3a of the bottom cover 3 that faces away from the battery cover 6→the other lead wire 50 derived from the substrate 40.

The switch pad 4 will be described in detail. According to one example, the diameter of the switch pad 4 is about 40 mm when the diameter of the LED coaster 10 is about 90 mm. The diameter of the switch pad 4 is about just under ½ of the diameter of the LED coaster 10.

The switch pad 4 and the two rubber pads 5 are arranged near the outer periphery of the bottom of the bottom cover 3 at approximately equal intervals in the circumferential direction. While the two rubber pads 5 are fixed on the bottom of the bottom cover 3, the circular holes in the four protruding parts 4d of the switch pad 4 are guided to the four pins 3d set up on the reverse side of the bottom cover 3, and the switch pad 4 is moveable in the direction of thickness of the LED coaster 10 (vertically).

In principle, the switch pressing part 4a (see FIG. 6) pressing the switch 30 of the switch pad 4 is provided approximately at the center of the switch pad 4.

When the LED coaster 10 is placed on a table, etc. and a glass, etc. containing a beverage is placed on the LED coaster 10, the weight of the glass is dispersed over the switch pad 4 and the two rubber pads 5 and thus supported by the table, etc.

The distance L1 of the switch pressing part 4a of the switch pad 4 from the center of the LED coaster 10 (see FIGS. 3 and 6) is about 19 mm according to one example, when the diameter of the LED coaster 10 is about 90 mm.

On the other hand, the distances of the two rubber pads 5 from the center of the LED coaster 10 are about 36 mm according to one example, when the diameter of the LED coaster 10 is about 90 mm. Further, the distance between the two rubber pads 5 is about 62 mm.

Since the switch pad 4 and the two rubber pads 5 have the above positional relationship, the weight of the glass, etc. is dispersed over the switch pad 4 and the two rubber pads 5 and thus supported by the table, etc. The weight of the glass is applied mainly to the switch pad 4 so that the switch pressing part 4a of the switch pad 4 presses the switch 30 and thus lights the LED 20.

According to one example, the diameter of the switch pad 4 is about 40 mm when the diameter of the LED coaster 10 is about 90 mm. Now, a case is assumed where the diameter of the switch pad 4 is reduced, e.g., to the same as the diameter of the conventional switch pad 104 (about 7 mm) and the switch pad 4 is arranged near the outer periphery of the bottom of the bottom cover 3. In this case, the weight of the glass, etc. is dispersed approximately equally over the switch pad 4 and the rubber pads 5 to which it is applied. As a result, the weight applied to the switch pad 4 decreases in comparison with the case of the switch pad 4 having a diameter of about 40 mm, and it is likely that the switch 30 is not operated.

While the diameter of the switch pad 4 is about 40 mm, a case is assumed where the diameter of the switch pad 4 is reduced, e.g., to the same as the diameter of the conventional switch pad 104 (about 7 mm) and the switch pad 4 is arranged approximately at the center of the bottom of the bottom cover 3. In this case, the weight of the glass, etc. is applied mainly to the switch pad 4 and the switch 30 is operated. In case the glass, etc. is placed on the LED coaster 10 toward the side opposite the two rubber pads 5, there is nothing to support the LED coaster 10 on the side opposite the two rubber pads 5, so that the glass, etc. is likely to incline.

Accordingly, it is preferable that the switch pad 4 is positioned near the outer periphery of the bottom cover 3, and that the diameter of the switch pad 4 is made as large as possible in order to position the switch pressing part 4a of the switch pad 4 near the center of the bottom of the bottom cover 3.

An LED coaster 10 with a circular outer shape has been described. However, the outer shape is not limited to a circular shape but can be chosen at will.

As explained above, the LED coaster 10 is supported by the table, etc. at three points, i.e. the switch pad 4 and the two rubber pads 5, which are arranged near the outer periphery of the bottom of the bottom cover 3. At the same time, the diameter of the switch pad 4 having the switch pressing part 4a approximately at its center is set to about just under ½ of the diameter of the LED coaster 10. In this manner, when a glass, etc. containing a beverage is placed on the LED coaster 10, the switch pressing part 4a of the switch pad 4 definitely presses the switch 30 and turns the switch 30 on, and thanks to the coaster 10 not being shaky, the glass, etc, containing a beverage can be placed on the LED coaster 10.

### EXPLANATION OF REFERENCE NUMERALS

1, 101 light transmitting cover
1a, 1b, 101a, 101b light transmitting part
2, 102 upper surface circumferential cover
3, 103 bottom cover
3a battery storage part
3b, 3c boss part
3d pin
3e hole
4, 104 switch pad
4a switch pressing part
4b flange part
4c placing surface
4d protruding part
5, 105 rubber pad
6, 106 battery cover
7, 9, 107 screw
10, 110 LED coaster
12 battery terminal
20 LED
30 switch
40 substrate
50 lead wire
60 button battery
108 cup

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An LED coaster, comprising:
a light transmitting cover, on the upper surface of which an object is placed;
a bottom cover attached to the lower surface of the light transmitting cover;
a substrate provided between the light transmitting cover and the bottom cover, comprising an LED mounted on a component surface on the light transmitting cover side and comprising a switch that turns the LED on and off mounted on a solder surface on the bottom cover side;
batteries contained in a battery storage part of the bottom cover to supply electric power to the LED;
two rubber pads attached to the bottom surface of the bottom cover; and
a switch pad that is attached to the inside of the bottom cover in a vertically moveable manner and on which a switch pressing part facing the switch is arranged,
wherein the two rubber pads and the switch pad are arranged near the outer periphery of the bottom of the bottom cover at approximately equal intervals in a circumferential direction, and the diameter of the switch pad is set to just under ½ of the diameter of the LED coaster.

2. The LED coaster according to claim 1, wherein the LED mounted on the substrate is located approximately at the center of the LED coaster.

3. The LED coaster according to claim 1, wherein the light transmitting cover comprises light transmitting parts approximately at its center and on its side surface, through which the light of the LED is transmitted.

4. The LED coaster according to claim 1, wherein the switch pressing part of the switch pad is arranged approximately at the center of the switch pad.

5. The LED coaster according to claim 4, wherein the switch pressing part is cross-shaped.

6. The LED coaster according to claim 1, wherein, in a state where the LED coaster is not placed on a table, etc., the relationship d1>d2 is fulfilled, where d1 designates the size of the switch pad in the direction in which it protrudes outward from the bottom of the bottom cover of the switch pad, and d2 designates the size of the rubber pads in the direction in which they protrude outward from the bottom cover.

7. The LED coaster according to claim 1, wherein the two rubber pads are arranged at an interval of about 120 degrees, with the battery storage part of the bottom cover lying between the rubber pads.

8. The LED coaster according to claim 1, wherein the battery storage part of the bottom cover is formed as a concave portion which is a convex portion when seen from the inside of the bottom cover and, after the batteries are stored in the battery storage part, the battery storage part is closed with the battery cover.

9. The LED coaster according to claim 1, wherein holes in the protruding parts of the switch pad are guided to a plurality of pins set up on the reverse side of the bottom cover, so that the switch pad can move in a direction of the thickness of the LED coaster.
